(19) United States
(12) Patent Application Publication
(10) Pub. No.: US 2019/0224714 A1
(43) Pub. Date: Jul. 25, 2019

(54) PROCESS FOR PREPARING CONTACT LENS WITH FILM BY PLASMA UV INDUCED GRAFTING POLYMERIZATION

(71) Applicant: BRIGHTEN OPTIX CORP., Taipei (TW)

(72) Inventors: Meng-Jiy WANG, Taipei (TW); Wen-Pin LIN, Taipei (TW); Yi-Zeng SUN, Taipei (TW)

(21) Appl. No.: 16/238,169

(22) Filed: Jan. 2, 2019

(30) Foreign Application Priority Data
Jan. 22, 2018 (TW) 107102244

(51) Int. Cl. B05D 3/14; B05D 1/18; B05D 3/10

(52) U.S. Cl. CPC B05D 3/147; B05D 3/107; B05D 1/185

(57) ABSTRACT

A process for preparing contact lens with film by plasma UV induced grafting polymerization is disclosed to plasma-modification on contact lens to form hydrophilic functional groups on said contact lens surface, and then to immerse said contact lens in a solution of the mixture of NVP, PEGMA and photoinitiator, and then remove said contact lens from said solution and expose said contact lens to an ultraviolet light from an ultraviolet device to form a thin film on said contact lens surface. Through the thin film, the contact lens can have good hydrophilicity and anti-fouling properties, so when the patient wear said contact lens, he or she does not feel uncomfortable foreign body sensation, significantly reducing deposit and corneal infection risk.

This application claims the priority benefit of Taiwan patent application number 107102244, filed on Jan. 22, 2018.

### BACKGROUND OF THE INVENTION

### 1. Field of the Invention

The present invention relates to contact lens processing technology and more particularly, to a process for preparing contact lens with film prepared by plasma UV induced grafting polymerization, which creates a thin film on the surface of the contact lens through plasma modification, solution immersion, and ultraviolet radiation processes, enabling the contact lens to provide stable hydrophilicity and for reducing protein and bacteria adsorption.

### 2. Description of the Related Art

The developments of electronic products have facilitated the daily life of people. In particular, the heavily utilization of the 3C (computers, communications, and consumer) electronic products have become inevitable routine for most of the people. The overuses of 3C products among certain office workers, students, middle aged and elderly people may lead to vision impairment. The studies reported by King's College of London study at 2015 explored the possible links between the increased number of patients of myopia and the heavily uses of computers and smartphone.

However, in order to correct myopia, also known as near-sightness and short-sightness, people may need to wear glasses or contact lenses. At present, in order to correct myopia, most of the people wear glasses, contact lenses or orthokeratology lenses, or undergo a surgical procedure to permanently and safely correct their myopia. Contact lens manufacturers generally apply plasma surface modification on the contact lenses to improve the hydrophilicity of contact lenses. However, most of these hydrophilic effects can only last for about one or two weeks due to the following reasons:

(1) Reconstructing of chemical functional groups created during and after plasma treatment for the minimization of its surface energy and transfer to an equilibrium state.

(2) Initiation of new oxidation and degradation reactions on the modified surface after exposuring air.

(3) Migration of low molecular weight oxidized macromolecules into the bulk film through the attainment of a more thermodynamically stable state with a lower surface free energy.

(4) The tendency of the low molecular weight compounds to be released from the bulk material to the surface.

(5) Reorientation of the bulk polar chemical functional groups especially those are near the surface.

(6) Relaxation of the surface roughness, promoting hydrophobic recovery degree and inducing the formation of low molecular weight layer with lower free surface energy on the surface.

Because of the above reasons, the hydrophobicity of the contact lens increases gradually after a week of plasma surface modification treatment, and on the 10^{th} to the 14^{th} day, the water contact angle of the contact lens will return to the original water contact angle as the pristine contact lens. When the patient wears hydrophobic contact lenses, the patient will have an uncomfortable feeling because of the foreign body interaction, which forced the patient to give up wearing lenses. Furthermore, the hydrophobic lenses were reported to be easily adhered by proteins which will cover on the lenses and therefore have impact on the user's vision and comfort. In addition, the protein rich environment is a breeding ground for bacteria. When the denatured protein initiates an allergic reaction, leading to giant papillary conjunctivitis (GPC), corneal infections such as acute red eyes, and prolonged wearing of contact lenses became impossible.

Therefore, it is desirable to provide contact lenses that can eliminate the aforementioned problems.

### SUMMARY OF THE INVENTION

The present invention has been accomplished under the circumstances in view. Therefore, the first object of the present invention is to employ a process to prepare contact lens with a coating to introduce the hydrophilic functional groups on the surfaces of contact lens by plasma UV induced grafting polymerization. The process is consisted of immersing the contact lens in a solution containing the mixtures of n-vinyl-2-pyrrolidone (NVP), poly(ethylene glycol)methacrylate (PEGMA), and photoinitiator, followed by ultraviolet light irradiation to expose the contact lens under ultraviolet light, allowing the formation of a thin film on the surface of contact lens so that the contact lens can reveal stable hydrophilicity and antifouling properties provided by the thin film.

The second object of the present invention is to provide a process to prepare contact lens with a layer of thin film by plasma UV induced grafting polymerization, which introduces hydrophilic functional groups on the surface of contact lens with the grafted NVP and PEGMA functionalities, and this can slow down the process of hydrophobicity recovery for the surface to a state with the minimized surface energy and returning to the thermal equilibrium state, thereby a great extent the wetting properties of the surface for a long period of time.

The third object of the present invention is to provide a process to prepare contact lens with films by plasma UV induced grafting polymerization, which leads to the formation of hydrophilic functional groups on the surface of contact lens to improve the hydrophilicity. The functional groups can also enhance adherence of NVP and PEGMA to the contact lens surface to promote the stability of the thin films on the surface of contact lens.

The fourth object of the present invention is to provide a process to prepare contact lens with films by plasma UV induced grafting polymerization, which enables thin film to be formed on the surface of contact lens after immersion so that the contact lens covered with this thin film will be ensured to be in contact with the cornea of patients, such that the hydrophilicity and fouling resistance of the contact lens can be carried out. The biocompatibility experiments confirmed that the grafting of NVP and PEGMA on the surface of contact lens does not induce significant cytotoxicity after grafting polymerization, so that the patient can wear this contact lens with safety.

The fifth object of the present invention is to provide a process to prepare contact lens with film by plasma UV induced grafting polymerization, wherein the photoinitiator used in the immersed solution is a water-soluble photoinitiator composed of 2-hydroxy-2-methylpropiophenone (HMPP) and deionized water. The water-soluble photoinitiator can prevent the contact lens from deforming due to soaking in an organic solvent (for example, alcohol) of a water-insoluble photoinitiator during the irradiation of ultraviolet light, so that the thin film-coated contact lens of the present invention can be produced with reproducibility, thereby increasing the production yield rate.

The sixth object of the present invention is to provide a process to prepare contact lens with film by plasma UV induced grafting polymerization, such that when the molecules of NVP and PEGMA are irradiated with ultraviolet light, NVP and PEGMA will be grafted on the contact lens and to increase the bond strength,

further improving the hydrophilicity, reducing protein adsorption, and increasing the ability of fouling resistance.

The other advantages and features of the present invention will be fully understood by reference to the following specification in conjunction with the accompanying drawings, in which the reference denote the components of structure.

### BRIEF DESCRIPTION OF THE DRAWINGS

FIG. 1 is the flow chart of the process for preparing contact lens with film by plasma UV induced grafting polymerization in accordance with the present invention (I).

FIG. 2 is the flow chart of the process for preparing contact lens with film by plasma UV induced grafting polymerization in accordance with the present invention (II).

FIG. 3 is the chemical formula of n-vinyl-2-pyrrolidone grafted by using photoinitiator.

FIG. 4 is the chemical formula of poly(ethylene glycol)methacrylate grafted by using photoinitiator.

FIG. 5 is a chemical formula of n-vinyl-2-pyrrolidon grafted with poly(ethylene glycol)methacrylate according to the present invention.

FIG. 6 is the data of the water contact angle versus the storage day obtained from storing contact lens in saline according to the present invention.

FIG. 7 is the histogram illustrating the ability of the contact lens against the growth of Escherichia coli.

FIG. 8 is the histogram illustrating the ability of the contact lens against the growth of Staphylococcus aureus.

### DETAILED DESCRIPTION OF THE PREFERRED EMBODIMENT

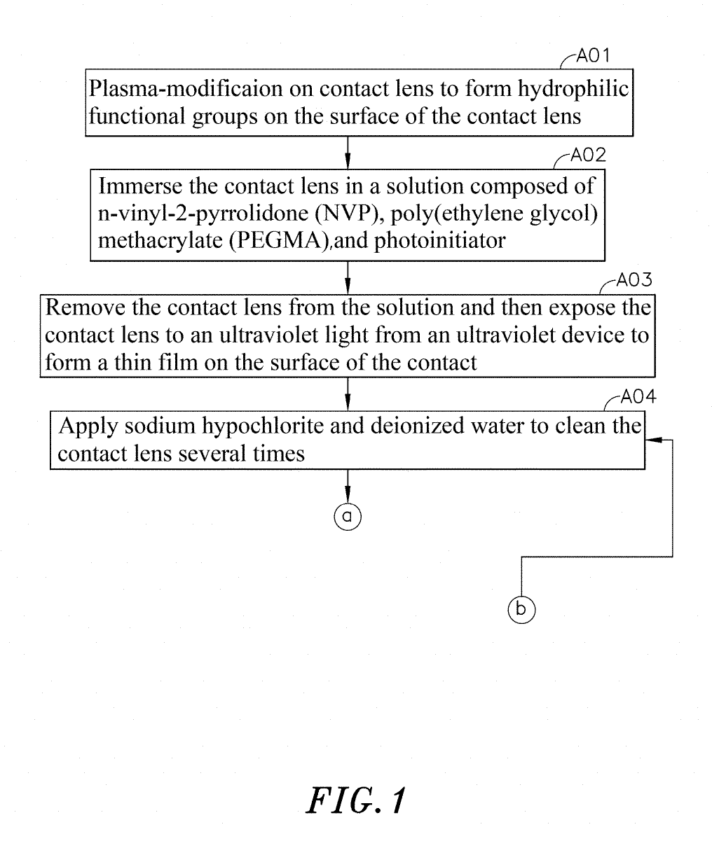

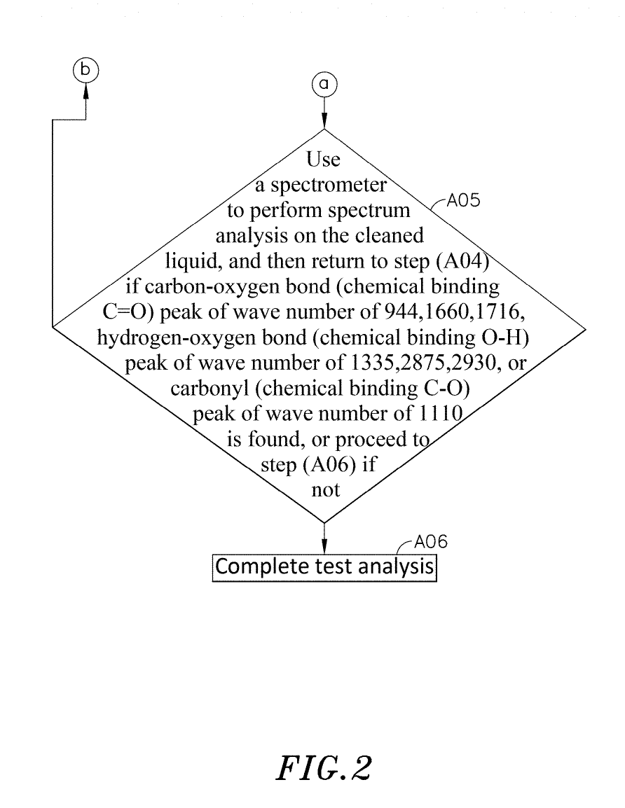

Referring to FIGS. 1 and 2, a process for preparing contact lens with film by plasma UV induced grafting polymerization comprises the steps of:

(A01) introducing hydrophilic functional groups on the said contact lens surface after plasma surface modification;

(A02) immersing the said contact lens in the said solution composed of n-vinyl-2-pyrrolidone (NVP), poly(ethylene glycol)methacrylate (PEGMA), and photoinitiator; and

(A03) removing the said contact lens from the said solution and then exposing the said contact lens to an ultraviolet light from an ultraviolet device to form a thin film on the said contact lens surface.

A contact lens with a thin film is thus made.

The aforesaid contact lens is preferably selected from contact lens materials such as polymethyl methacrylate (PMMA), fluorosilicic acid (FSA), polyhydroxyethyl methacrylate, GMMA, silicone hydrogel and lenses made from semi rigid gas permeable contact lenses.

In step (A01), contact lens with plasma modification is achieved by a plasma apparatus, and the plasma treatment parameters (power, plasma treatment time, flow rate, and working pressure) are set to be 70˜80 W, 90˜120 s, 5˜10 sccm and 80˜100 mTorr respectively, or preferably, 80 W, 120 s, 10 sccm and 100 mTorr respectively. Hydrophilic functional groups can be introduced stably on the said contact lens surface by the aforementioned parameters, and the water contact angle (WCA) on the said contact lens surface after plasma modification treatment can be 38±1.91°.

Further, in the said solution of mixture of NVP, PEGMA and photoinitiator in step (A02), the volume percent concentration of NVP is in the range of 40˜60 v/v % or preferably 40 v/v %, the volume percent concentration of PEGMA is in the range of 40˜60 v/v % or preferably 60 v/v %, the photoinitiator is a water soluble photoinitiator consisting of 2-hydroxy-2-methylpropiophenone (HMPP) and deionized water, and the volume percent concentration of photoinitiator is in the range of 0.5˜1.0 v/v %. Thus, the aforementioned parameters are used to optimize the graft density of the thin film formed on the surface of contact lens, thereby reducing the water contact angle (WCA) and improving the hydrophilicity of the contact lens.

Further, in step (A03), the UV light is applied at a wavelength of 254 nm, the power of 60 W and is controlled to emit onto said contact lens for an irradiation time of 20˜30 minutes to cure NVP and PEGMA with photoinitiator onto said contact lens surface to form the desired thin film, and NVP and PEGMA are mutually grafted after ultraviolet radiation. Subject to the aforementioned values, NVP and PEGMA are grafted onto the said contact lens without altering the physical and chemical properties.

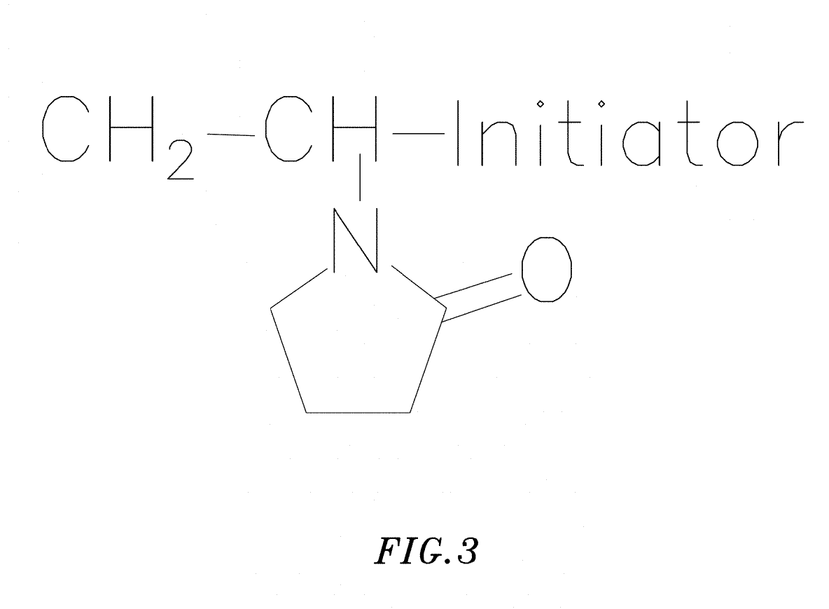

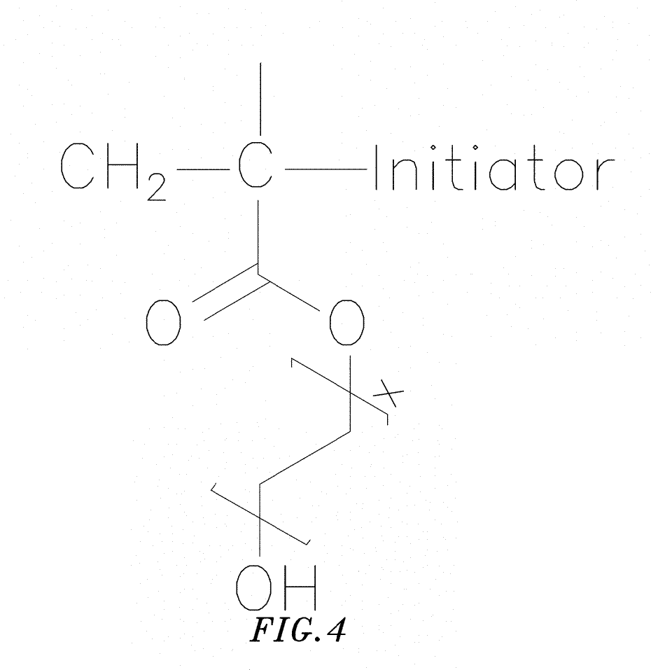

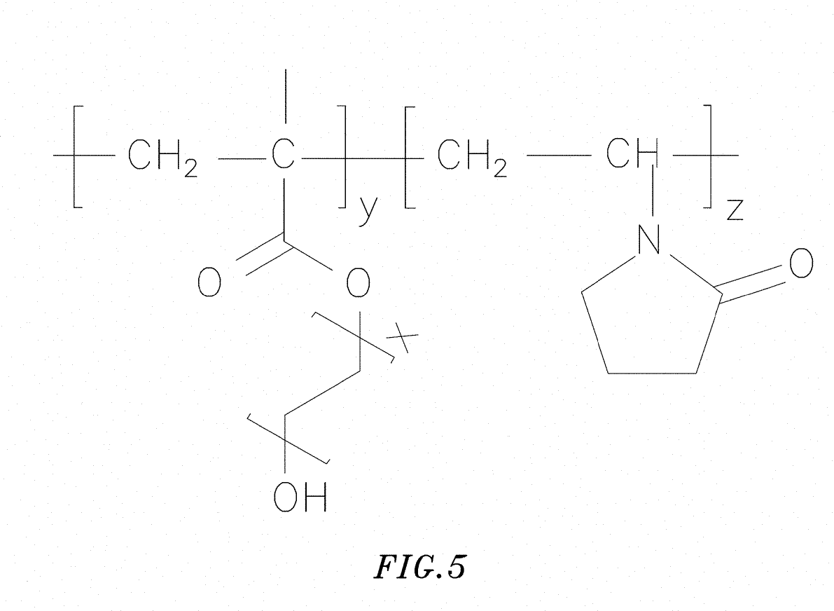

Referring to FIGS. 3, 4 and 5 that illustrate the chemical formula of NVP grafted with photoinitiator, the chemical formula of PEGMA grafted with photoinitiator and a chemical formula of NVP grafted with PEGMA according to the present invention. As illustrated, after NVP and PEGMA are irradiated with ultraviolet light, they are chemically grafted, which allow increasing the bonding strength.

In the actual applications, the invention uses a plasma apparatus to the contact lens surface with plasma modification, thereby forming hydrophilic functional groups on the surface of contact lens. Thereafter, the said contact lens is immersed in the said solution formed of n-vinyl-2-pyrrolidone (NVP), poly(ethylene glycol)methacrylate (PEGMA) and photoinitiator so that the said contact lens surface is actually in contact with the solution. Then, the said contact lens is removed from the solution and then exposed to an ultraviolet light. In the process of ultraviolet light irradiation, the photoinitiator in the solution induces NVP and PEGMA grafted onto the functional groups on the said contact lens surface, and the contact lens with a thin film is thus made. NVP and PEGMA are well-known for their biocompatible and hydrophilic properties, and can be grafted onto the surface of biomaterials to reduce the adhesion of proteins and suppression of cell/bacteria attachment. Because NVP is a hydrophilic polymer, and the grafting PEGMA has the ability to prevent nonspecific protein adsorption and to increase the fouling resistance. Biocompatibility tests (for example, in vitro cytotoxicity test, acute system toxicity test, ocular irritation test and skin sensitivity test, etc.) have proved that the said contact lens after grafting polymerization will not induce significant cytotoxicity. The thickness of the thin film is so thin (1˜10 μm) that when the patient wear the said contact lens, he or she would not undergo uncomfortable foreign body sensation, meaning the method has significantly reduced the deposition of proteins and to prevent the risk of corneal infection.

After the above step (A03), steps (A04), (A05) and (A06) can be further proceeded

(A04) Washing the said contact lens with sodium hypochlorite (NaOCl) solution and deionized water respectively for a predetermined number of times.

(A05) Use a spectrometer to perform spectrum analysis on the solution, and then return to step (A04) if there is a characteristic peak at 1660 cm⁻¹ due to C═O stretching of PVP, a characteristic peak at 1335 cm⁻¹ due to O—H stretching of PVP, a characteristic peak at 2930, 2875 cm⁻¹ due to C—H stretching of PEGMA, a characteristic peak at 1716, 944 cm⁻¹ due to C═O stretching of PEGMA, and a characteristic peak at 1110, 890 cm⁻¹ due to C—O stretching of PEGMA, or proceeding to step (A06) if any of the above peaks was not observed in the IR spectra.

(A06) Completing spectrum analysis.

In step (A04), the predetermined number of cleaning process is 1˜5 times, or preferably, 3 times.

In step (A05), the spectrometer can be a Fourier transform infrared spectrometer (FTIR) or any other equipment that can perform chemical surface analysis of substances.

After formation of the thin film on the surface of the contact lens, sodium hypochlorite and deionized water are used to clean said contact lens, and then a spectrometer is used to perform spectrum analysis on the solution. If there is a characteristic peak at 1660 cm⁻¹ due to C═O stretching of PVP, a characteristic peak at 1335 cm⁻¹ due to O—H stretching of PVP, a characteristic peak at 2930, 2875 cm⁻¹ due to C—H stretching of PEGMA, a characteristic peak at 1716, 944 cm⁻¹ due to C═O stretching of PEGMA, and a characteristic peak at 1110, 890 cm⁻¹ due to C—O stretching of PEGMA in the IR spectra, repeat the cleaning process. On the other hand, if any of the above peak was not observed in the IR spectra, it means that NVP and PEGMA have been grafted onto the surface of contact lens successfully. Therefore, by spectrum analysis, it can confirm that NVP and PEGMA are indeed grafted on the surface of contact lens, thereby having the effect of convenience for validation of product quality.

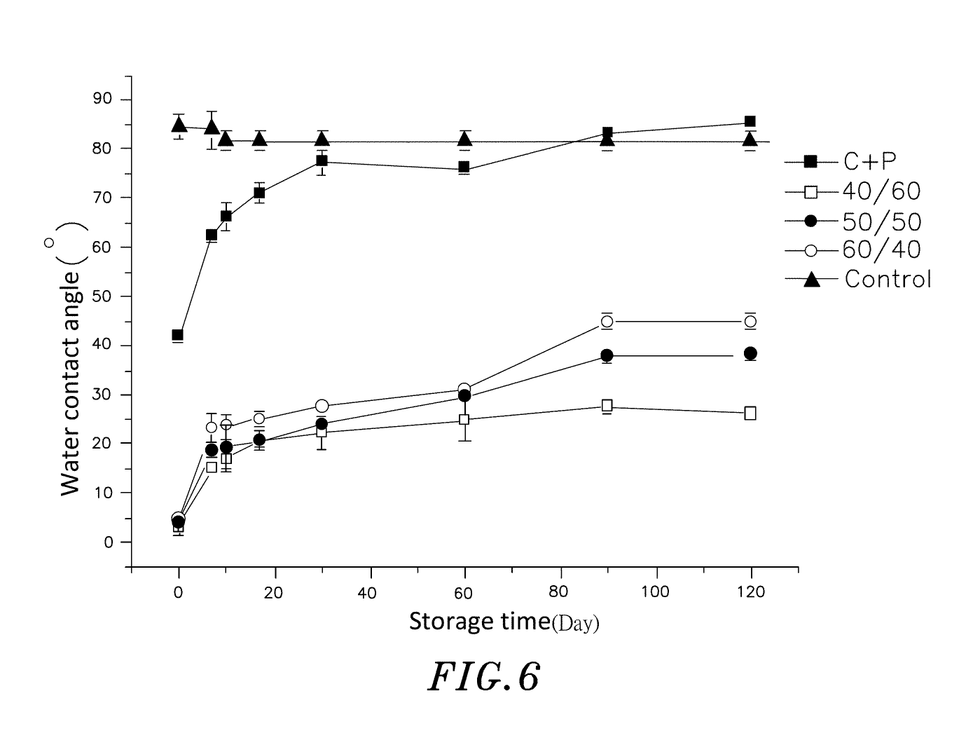

FIG. 6 shows a static water contact angle as function of the storage period obtained from storing the said contact lens in saline according to the present invention. In FIG. 6, the vertical axis is the water contact angle; the horizontal axis is the storage period; the solid square curve (C+P) is an experimental curve of the contact lens only treated with plasma; the hollow square curve (40/60) is an experimental curve of a contact lens immersed in the said solution with the volume percent concentration of NVP and PEGMA are 40 v/v % and 60 v/v %; the solid circle curve (50/50) is an experimental curve of a contact lens immersed in the said solution which the volume percent concentration of NVP and PEGMA are 50 v/v % and 50 v/v %; the hollow round curve (60/40) is an experimental curve of a contact lens immersed in the said solution with the volume percent concentration of NVP and PEGMA are 60 v/v % and 40 v/v %; the solid triangle curve (Control) is the control curve of a pristine contact lens.

It can be clearly seen from the foregoing multiple curves that for the stored time for 120 days, the water contact angle of the said thin film-coated contact lenses is significantly lower than that of the pristine contact lens and the contact lens which only undergo plasma treatment. This shows that the thin film can increase the hydrophilicity of the contact lens.

For the stored time for 120 days, the water contact angle of the hollow square curve (40/60) is the lowest (about 25°) in the curves of FIG. 6, so it can be known that the volume percent concentration of NVP and PEGMA are 40 v/v % and 60 v/v % respectively, and this can improve the hydrophilic property of the contact lens significantly.

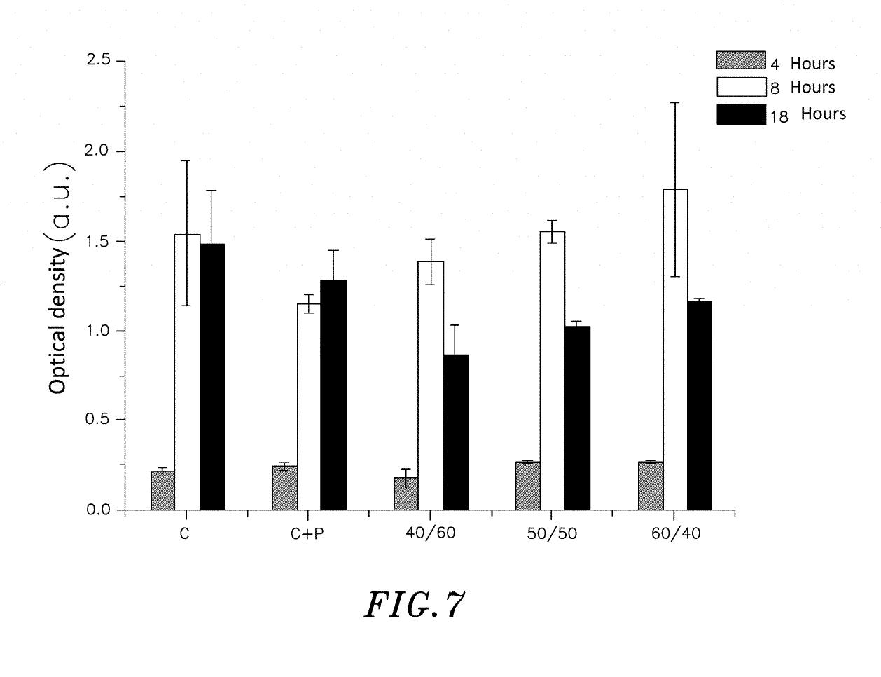

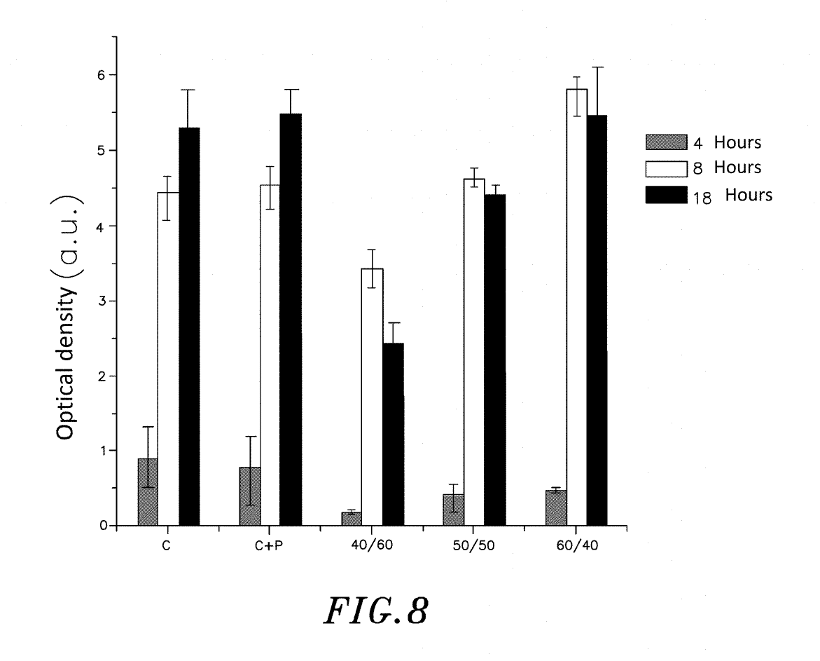

FIGS. 7 and 8 are the histograms illustrating the ability of the contact lens against the growth of Escherichia coli and Staphylococcus aureus respectively. It can be clearly observed from the histograms that when the volume percent concentrations of NVP, PEGMA are 40 v/v % and 60 v/v %, respectively, regardless Escherichia coli or Staphylococcus aureus is detected, the optical density that can be detected at 18 hours is the lowest among the various kinds of contact lenses. Therefore, the volume percent concentration of NVP, PEGMA is 40% and 60% show the best outcome for the fouling resistance.

In conclusion, the invention has the advantages as follow:

1. A thin film can be formed on the surface of contact lens through plasma modification, solution immersion and ultraviolet light irradiation, and the said contact lens can reveal stable hydrophilicity and anti-fouling properties.

2. After plasma-modification, hydrophilic functional groups are introduced on the said contact lens surface, and the functional groups are grafted with NVP and PEGMA in the solution, and this can slow down the process of hydrophobicity recovery for recovering to a state with minimized surface energy and returning to thermal equilibrium state, thereby achieving the long-lasting hydrophilic surface.

3. After the plasma-modification, hydrophilic functional groups are formed on the said contact lens surface to improve the hydrophilicity, and the functional groups can also enhance adherence of NVP and PEGMA to the said contact lens surface to achieve the effect of increasing the formation and stability of the thin film on the contact lens surface.

4. Through immersion, the thin film is formed on the contact lens surface. Therefore, when the patient wear contact lens with this thin film will surely come into contact with the user's cornea, so that the hydrophilicity and anti-fouling function of the contact lens can be fully carried out. The biocompatibility experiments confirmed that grafting NVP and PEGMA on contact lens surface does not induce significant cytotoxicity after grafting polymerization, so that the patient can wear this contact lens safely.

5. The photoinitiator is a water-soluble photoinitiator composed of 2-hydroxy-2-methylpropiophenone (HMPP) and deionized water. The water-soluble photoinitiator can prevent the contact lens from deforming due to the immersion of an organic solvent (for example, alcohol) of a water-insoluble photoinitiator during the irradiation of ultraviolet light, so that the said thin film-coated contact lens of the present invention can be stably produced, thereby increasing the production yield rate.

6. When NVP and PEGMA are irradiated with ultraviolet light, they will also be grafted to increase the bonding strength, further improving the hydrophilicity, reducing the adsorption of protein and increasing the ability to fouling resistance.

Although the particular embodiments of the invention have been described in detail for purposes of illustration, various modifications and enhancements may be made without departing from the goal and scope of the invention. Accordingly, the invention is not to be limited except as by the appended claims.

What the invention claimed is:

1. A process for preparing contact lens with film by plasma UV induced grafting polymerization, comprising the steps of:
(A01) introducing hydrophilic functional groups on said contact lens surface after plasma surface modification;
(A02) immerse said contact lens in a solution of the mixture of NVP, PEGMA and photoinitiator;
(A03) removing said contact lens from said solution and then exposing said contact lens to an ultraviolet light from an ultraviolet device to form a thin film on said contact lens surface.

2. The process for preparing contact lens with film by plasma UV induced grafting polymerization as claimed in claim 1, wherein said contact lens material such as Poly (methyl methacrylate (PMMA), fluorosilicic acid (FSA), polyhydroxyethyl methacrylate, GMMA, silicone hydrogel and lenses made from semi rigid gas permeable contact lenses.

3. The process for preparing contact lens with film by plasma UV induced grafting polymerization as claimed in claim 1, wherein in step (A01), plasma-modification on said contact lens surface is achieved by a plasma apparatus, and the plasma treatment parameters (power, plasma treatment time, flow rate, and working pressure) are set to 70˜80 W, 90˜120 s, 5˜10 sccm and 80˜100 mTorr respectively, or preferably, 80 W, 120 s, 10 sccm and 100 mTorr respectively.

4. The process for preparing contact lens with film by plasma UV induced grafting polymerization as claimed in claim 3, wherein said plasma apparatus is an argon plasma apparatus.

5. The process for preparing contact lens with film by plasma UV induced grafting polymerization as claimed in claim 1, wherein in said solution of said mixture of N-vinyl-2-pyrrolidone, poly(ethylene glycol)methacrylate and photoinitiator in step (A02), the volume percent concentration of NVP is in the range of 40˜60 v/v % or preferably 40 v/v %, the volume percent concentration of PEGMA is in the range of 40˜60 v/v % or preferably 60 v/v %, the volume percent concentration of photoinitiator is in the range of 0.5˜1.0 v/v %.

6. The process for preparing contact lens with film by plasma UV induced grafting polymerization as claimed in claim 1, wherein said photoinitiator in step (A02) is a water soluble photoinitiator consisting of 2-hydroxy-2-methylpropiophenone (HMPP) and deionized water.

7. The process for preparing contact lens with film by plasma UV induced grafting polymerization as claimed in claim 1, wherein in step (A03), said UV light is applied at a wavelength of 254 nm, at the power of 60 W and is controlled to emit onto said contact lens for an irradiation time of 20˜30 minutes to cure NVP and PEGMA with photoinitiator onto said contact lens surface to form the desired thin film, and NVP and PEGMA are mutually grafted with each other after ultraviolet radiation.

8. The process for preparing contact lens with film by plasma UV induced grafting polymerization as claimed in claim 1, further comprising, after step (A03), the steps of:
(A04) Washing said contact lens with sodium hypochlorite (NaOCl) solution and deionized water respectively for a predetermined number of times;
(A05) Use a spectrometer to perform spectrum analysis on the solution, and then return to step (A04) if there is a characteristic peak at 1660 cm⁻¹ due to C═O stretching of PVP, a characteristic peak at 1335 cm⁻¹ due to O—H stretching of PVP, a characteristic peak at 2930, 2875 cm⁻¹ due to C—H stretching of PEGMA, a characteristic peak at 1716, 944 cm⁻¹ due to C═O stretching of PEGMA, and a characteristic peak at 1110, 890 cm⁻¹ due to C—O stretching of PEGMA, or proceeding to step (A06) if any of the above peak was not observed in the IR spectra;
(A06) Completing spectrum analysis.

9. The process for preparing contact lens with film by plasma UV induced grafting polymerization as claimed in claim 8, wherein in step (A04), said predetermined number of cleaning process is 1˜5 times or preferably, 3 times.

10. The process for preparing contact lens with film by plasma UV induced grafting polymerization as claimed in claim 8, wherein in step (A05), said spectrometer is a Fourier transform infrared spectrometer.
